(19) United States
(12) Patent Application Publication
(10) Pub. No.: US 2016/0084998 A1
(43) Pub. Date: Mar. 24, 2016

(54) LIGHT-DIFFUSING ELEMENT

(71) Applicant: NITTO DENKO CORPORATION, Ibaraki-shi, Osaka (JP)

(72) Inventors: Kozo Nakamura, Ibaraki-shi (JP); Takehito Fuchida, Ibaraki-shi (JP); Hiroyuki Takemoto, Ibaraki-shi (JP); Seiji Umemoto, Ibaraki-shi (JP)

(73) Assignee: NITTO DENKO CORPORATION, Ibaraki-shi, Osaka (JP)

(21) Appl. No.: 14/783,723

(22) PCT Filed: Apr. 10, 2013
(86) PCT No.: PCT/JP2013/060805

§ 371 Date: Oct. 9, 2015

(51) Int. Cl. G02B 5/02

(52) U.S. Cl. CPC G02B 5/0242

(57) ABSTRACT

Provided is a light diffusing element having a high haze value, strong diffusibility, and suppressed backscattering. The light diffusing element of the present invention includes a matrix including a resin component and ultrafine particle components, and light diffusing fine particles dispersed in the matrix, in which the ultrafine particle components have an average primary particle diameter of 100 nm or less, and in which the light diffusing element is substantially free of aggregated ultrafine particle components. In a preferred embodiment, the light diffusing fine particles have an average primary particle diameter of from 1 μm to 5 μm, the light diffusing fine particles have a coefficient of variation in weight average particle diameter distribution of 20% or less, and the light diffusing fine particles are substantially free of aggregation.

### TECHNICAL FIELD

The present invention relates to a light diffusing element.

### BACKGROUND ART

A light diffusing element is widely used in illumination covers, screens for projection televisions, surface-emitting apparatus (for example, liquid crystal display apparatus), and the like. In recent years, the light diffusing element has been used for enhancing the display quality of the liquid crystal display apparatus or the like and for improving a viewing angle characteristic, for example. As the light diffusing element, there has been proposed, for example, one obtained by dispersing fine particles in a matrix such as a resin sheet (see, for example, Patent Literature 1). However, such related-art light diffusing element has the following problems. Many of the fine particles in the light diffusing element are aggregated, and besides, particle diameters of the fine particles are not uniform. Accordingly, light diffusibility is insufficient and backscattering is significant.

### CITATION LIST

### Patent Literature

[PTL 1] JP 3071538 B2

### SUMMARY OF INVENTION

### Technical Problem

The present invention has been made in order to solve the problems of the related art described above, and an object of the present invention is to provide a light diffusing element having a high haze value, strong diffusibility, and suppressed backscattering.

### Solution to Problem

A light diffusing element according to one embodiment of the present invention includes: a matrix including a resin component and ultrafine particle components; and light diffusing fine particles dispersed in the matrix, in which the ultrafine particle components have an average primary particle diameter of 100 nm or less, and in which the light diffusing element is substantially free of aggregated ultrafine particle components.

In one embodiment of the present invention, the light diffusing fine particles have an average primary particle diameter of from 1 μm to 5 μm, the light diffusing fine particles have a coefficient of variation in weight average particle diameter distribution of 20% or less, and the light diffusing fine particles are substantially free of aggregation.

In one embodiment of the present invention, the ultrafine particle components have an average primary particle diameter of 30 nm or less.

In one embodiment of the present invention, refractive indices of the resin component, the ultrafine particle components, and the light diffusing fine particles satisfy the following expression (i), and the light diffusing element has a refractive index modulation region in a vicinity of a surface of each of the light diffusing fine particles:

|n_{P}−n_{A}|<|n_{P}−n_{B}| (i)

in the expression (i), n_{A} represents the refractive index of the resin component of the matrix, n_{B} represents the refractive index of each of the ultrafine particle components of the matrix, and n_{P} represents the refractive index of each of the light diffusing fine particles.

### Advantageous Effects of Invention

According to the embodiment of the present invention, the ultrafine particle components are contained in the matrix, and thus a refractive index difference between the matrix and each of the light diffusing fine particles can be increased. Consequently, the light diffusing element having a high haze value and strong diffusibility can be realized. In addition, the refractive index modulation region in which the refractive index substantially continuously changes can be formed in the vicinity of the surface of each of the light diffusing fine particles. As a result, reflection at an interface between the matrix and each of the light diffusing fine particles can be suppressed, and backscattering can be suppressed. Such effect becomes remarkable by virtue of the fact that the ultrafine particle components have small particle diameters and the light diffusing element is substantially free of aggregated ultrafine particle components. Specifically, the light diffusing element according to the embodiment of the present invention can prevent the increase of backscattering and the lowering of the utilization efficiency of light contributing to light diffusion, which are caused by an extreme concentration gradient occurring around the aggregated ultrafine particle components.

Further, when uniform light diffusing fine particles are used and the light diffusing fine particles are present in a state of being substantially free of aggregation, the above-mentioned effect becomes further remarkable and the transmission of light which advances straight without being diffused can be suppressed.

### BRIEF DESCRIPTION OF DRAWINGS

FIG. 1 is a schematic view for illustrating a dispersed state of a resin component of a matrix and light diffusing fine particles in a light diffusing element to be obtained by a manufacturing method according to a preferred embodiment of the present invention.

FIG. 2 is an enlarged schematic view for illustrating the vicinity of a light diffusing fine particle in a light diffusing element of the present invention.

FIG. 3 is a conceptual diagram for illustrating a change in refractive index from the center of the light diffusing fine particle to the matrix in the light diffusing element of the present invention.

FIG. 4 is a transmission electron microscope image for showing the area ratio of ultrafine particle components in the matrix.

FIG. 5 is a transmission micrograph for showing a cross-section of a light diffusing element obtained in Example 1.

### DESCRIPTION OF EMBODIMENTS

Now, preferred embodiments of the present invention are described with reference to the drawings. However, the present invention is not limited to these specific embodiments.

A. Light Diffusing Element

### A-1. Entire Construction

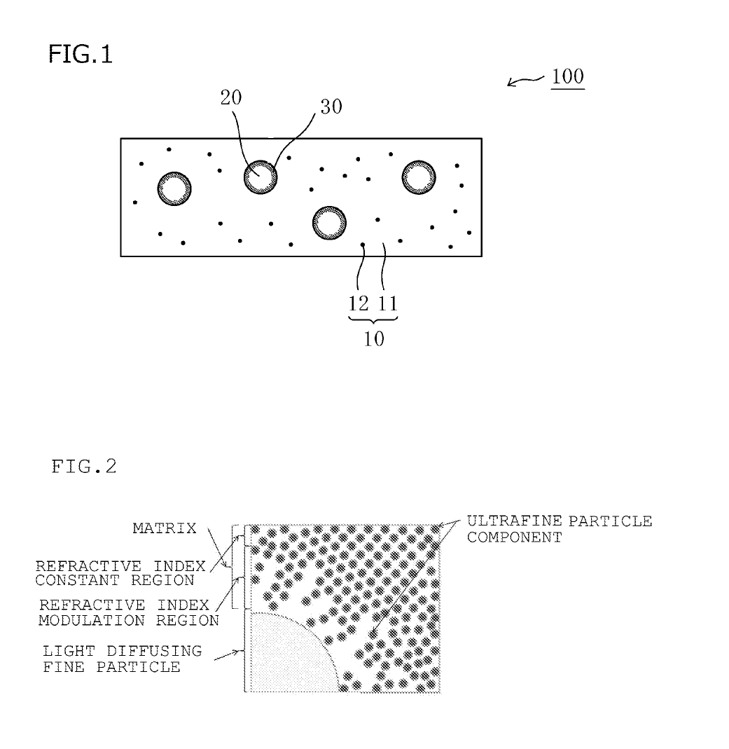

A light diffusing element of the present invention includes a matrix including a resin component and ultrafine particle components, and light diffusing fine particles dispersed in the matrix. The light diffusing element of the present invention expresses a light diffusing function by virtue of a refractive index difference between the matrix and each of the light diffusing fine particles. FIG. 1 is a schematic view for illustrating a dispersed state of a resin component and ultrafine particle components of a matrix, and light diffusing fine particles in a light diffusing element according to a preferred embodiment of the present invention. A light diffusing element 100 of the present invention includes a matrix 10 including a resin component 11 and ultrafine particle components 12 having an average primary particle diameter of 100 nm or less, and light diffusing fine particles 20 dispersed in the matrix 10. The light diffusing element of the present invention is substantially free of aggregated ultrafine particle components.

It is preferred that, as illustrated in FIG. 1 and FIG. 2, a refractive index modulation region 30 be formed in the vicinity of the surface of each of the light diffusing fine particles. Therefore, the matrix preferably has the refractive index modulation region 30 in the vicinity of the surface of each of the light diffusing fine particles, and a refractive index constant region on the outside (side away from the light diffusing fine particle) of the refractive index modulation region. In the refractive index modulation region 30, a refractive index substantially continuously changes. It is preferred that any other portion of the matrix than the refractive index modulation region 30 be substantially the refractive index constant region. The term “vicinity of the surface of each of the light diffusing fine particles” as used herein encompasses the surface of the light diffusing fine particle, the outside of the light diffusing fine particle near the surface, and the inside of the light diffusing fine particle near the surface. That is, the innermost portion of the refractive index modulation region may be present on the inside of the light diffusing fine particle.

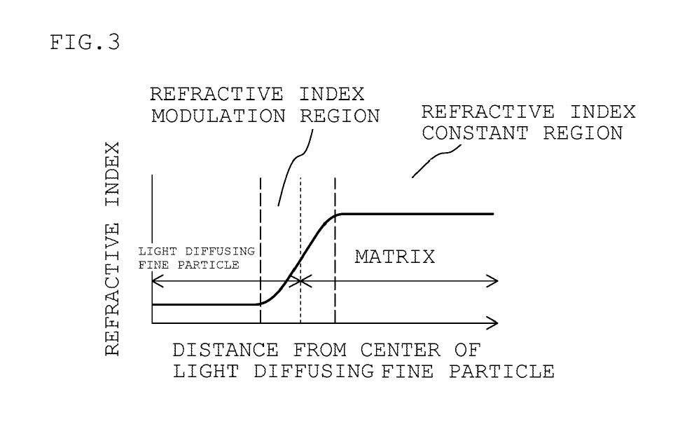

As described above, in the refractive index modulation region 30, the refractive index substantially continuously changes. In addition, it is preferred that the refractive index in an outermost portion of the refractive index modulation region and the refractive index of the refractive index constant region be substantially the same. In other words, in the light diffusing element, the refractive index continuously changes from the refractive index modulation region to the refractive index constant region, and the refractive index preferably continuously changes from the light diffusing fine particle to the refractive index constant region (FIG. 3). The change in refractive index is preferably smooth as illustrated in FIG. 3. That is, the refractive index changes in such a shape that a tangent can be drawn on a refractive index change curve at a boundary between the refractive index modulation region and the refractive index constant region. In the refractive index modulation region, the gradient of the change in refractive index preferably increases with increasing distance from the light diffusing fine particle. According to the light diffusing element of the present invention, a substantially continuous change in refractive index can be realized by appropriately selecting the light diffusing fine particles, and the resin component and the ultrafine particle components of the matrix. As a result, even when the refractive index difference between the matrix 10 (substantially the refractive index constant region) and each of the light diffusing fine particles 20 is increased, reflection at an interface between the matrix 10 and each of the light diffusing fine particles 20 can be suppressed, and backscattering can be suppressed. Further, in the refractive index constant region, the weight concentration of the ultrafine particle components 12 each having a refractive index significantly different from that of the light diffusing fine particle 20 is relatively high, and hence the refractive index difference between the matrix 10 (substantially the refractive index constant region) and the light diffusing fine particle 20 can be increased. As a result, even in a thin film, a high haze (strong diffusibility) can be realized. The phrase “the refractive index substantially continuously changes” as used herein means that the refractive index only needs to substantially continuously change at least from the light diffusing fine particle to the refractive index constant region in the refractive index modulation region. Therefore, for example, even when a refractive index gap in a predetermined range (e.g., a refractive index difference of 0.05 or less) is present at an interface between the light diffusing fine particle and the refractive index modulation region, and/or an interface between the refractive index modulation region and the refractive index constant region, the gap may be permitted.

The thickness of the refractive index modulation region 30 (distance from the innermost portion of the refractive index modulation region to the outermost portion of the refractive index modulation region) may be constant (that is, the refractive index modulation region may spread at the circumference of the light diffusing fine particle in a concentric sphere shape), or the thickness may vary depending on the position of the surface of the light diffusing fine particle (for example, the refractive index modulation region may have a shape similar to the contour of konpeito candy).

The refractive index modulation region 30 has an average thickness of preferably from 0.01 μm to 0.6 μm, more preferably from 0.03 μm to 0.5 μm, still more preferably from 0.04 μm to 0.4 μm, particularly preferably from 0.05 μm to 0.4 μm. The average thickness is an average thickness in the case where the thickness of the refractive index modulation region 30 varies depending on the position of the light diffusing fine particle surface, and in the case where the thickness is constant, is the constant thickness.

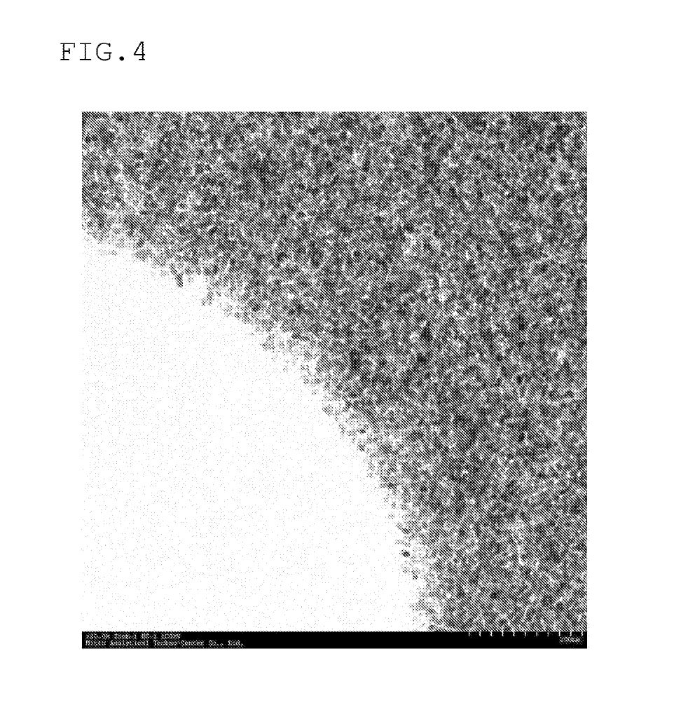

As described above, the matrix 10 includes the resin component 11 and the ultrafine particle components 12. It is preferred that the refractive index modulation region 30 be formed by a substantial gradient of the dispersion concentration of the ultrafine particle components 12 in the matrix 10. Specifically, in the refractive index modulation region 30, the dispersion concentration (typically specified in terms of weight concentration) of the ultrafine particle components 12 increases (inevitably, the weight concentration of the resin component 11 decreases) with increasing distance from the light diffusing fine particle 20. In other words, in a region of the refractive index modulation region 30 closest to the light diffusing fine particle 20, the ultrafine particle components 12 are dispersed at a relatively low concentration, and the concentration of the ultrafine particle components 12 increases with increasing distance from the light diffusing fine particle 20. For example, the area ratio of the ultrafine particle components 12 in the matrix 10 based on a transmission electron microscope (TEM) image is small on a side close to the light diffusing fine particle 20 and large on a side close to the matrix 10, and the area ratio changes while forming a substantial gradient from the light diffusing fine particle side to the matrix side (refractive index constant region side). A TEM image for showing a typical dispersed state of the ultrafine particle components is shown in FIG. 4. The term “area ratio of the ultrafine particle components in the matrix based on a transmission electron microscope image” as used herein refers to the ratio of the area occupied by the ultrafine particle components in the matrix in a predetermined range (predetermined area) in a transmission electron microscope image of a cross-section including the diameter of a light diffusing fine particle. The area ratio corresponds to the three-dimensional dispersion concentration (actual dispersion concentration) of the ultrafine particle components. The area ratio of the ultrafine particle components may be determined with any appropriate image analysis software. It should be noted that the area ratio typically corresponds to the average shortest distance between respective particles of the ultrafine particle components. Specifically, the average shortest distance between the respective particles of the ultrafine particle components decreases with increasing distance from the light diffusing fine particle in the refractive index modulation region, and becomes constant in the refractive index constant region (for example, the average shortest distance is from about 3 nm to 100 nm in a region closest to the light diffusing fine particle, and from 1 nm to 20 nm in the refractive index constant region). The average shortest distance may be calculated by binarizing a TEM image of a dispersed state as shown in FIG. 4 and using, for example, the inter-centroid distance method of image analysis software “A-zo-kun” (manufactured by Asahi Kasei Engineering Corporation). As described above, according to a manufacturing method of the present invention, the refractive index modulation region 30 can be formed in the vicinity of the surface of each of the light diffusing fine particles through the utilization of the substantial gradient of the dispersion concentration of the ultrafine particle components 12, and hence the light diffusing element can be manufactured by a much simpler procedure at much lower cost as compared to the case where GRIN fine particles are manufactured by a complicated manufacturing method and the GRIN fine particles are dispersed. Further, when the refractive index modulation region is formed through the utilization of the substantial gradient of the dispersion concentration of the ultrafine particle components, the refractive index can be allowed to smoothly change at a boundary between the refractive index modulation region 30 and the refractive index constant region. Further, through the use of ultrafine particle components each having a refractive index significantly different from those of the resin component and the light diffusing fine particles, the refractive index difference between each of the light diffusing fine particles and the matrix (substantially the refractive index constant region) can be increased, and the refractive index gradient of the refractive index modulation region can be made steep.

The refractive index modulation region (substantially the substantial gradient of the dispersion concentration of the ultrafine particle components as described above) may be formed by appropriately selecting materials for forming the resin component and the ultrafine particle components of the matrix, and the light diffusing fine particles, and chemical and thermodynamic characteristics thereof. For example, when the resin component and the light diffusing fine particles are formed of materials of the same type (e.g., organic compounds), and the ultrafine particle components are each formed of a material of a different type from the resin component and the light diffusing fine particles (e.g., an inorganic compound), the refractive index modulation region can be satisfactorily formed. Further, for example, it is preferred that the resin component and the light diffusing fine particles be formed of materials having high compatibility with each other among materials of the same type. The thickness and the refractive index gradient of the refractive index modulation region may be controlled by adjusting the chemical and thermodynamic characteristics of the resin component and the ultrafine particle components of the matrix, and the light diffusing fine particles. It should be noted that the term “same type” as used herein means that chemical structures and properties are equivalent or similar, and the term “different type” refers to a type other than the same type. Whether or not materials are of the same type varies depending on the way of selecting a standard. For example, based on whether materials are organic or inorganic, organic compounds are compounds of the same type, and an organic compound and an inorganic compound are compounds of different types. Based on a repeating unit of a polymer, for example, an acrylic polymer and an epoxy-based polymer are compounds of different types in spite of the fact that they are both organic compounds. Based on the periodic table, an alkaline metal and a transition metal are elements of different types in spite of the fact that they are both inorganic elements.

The haze value of the light diffusing element is preferably as high as possible. Specifically, the haze value is preferably 70% or more, more preferably from 90% to 99%, still more preferably from 92% to 99.5%, yet still more preferably from 95% to 99.5%, particularly preferably from 97% to 99.5%, most preferably from 98.6% to 99.5%. When the haze value is 70% or more, the light diffusing element can be suitably used as a front light diffusing element in a collimated backlight front diffusing system. It should be noted that the collimated backlight front diffusing system refers to a system in which a front light diffusing element is arranged on a viewer side of an upper polarizing plate, using collimated backlight light (backlight light having a narrow brightness half-width condensed in a constant direction) in a liquid crystal display apparatus.

The diffusion characteristic of the light diffusing element in terms of light diffusion half-angle is preferably from 10° to 150° (one side: 5° to 75°), more preferably from 10° to 100° (one side: 5° to 50°), still more preferably from 30° to 80° (one side: 15° to 40°).

When a parallel light beam is allowed to enter the light diffusing element perpendicularly, the transmittance of light parallel to incident light is preferably 2% or less, more preferably 1% or less. In the present invention, the light diffusing element is substantially free of aggregated ultrafine particle components, and hence light to be transmitted without being affected by the light diffusing fine particles and the refractive index modulation region can be reduced. Thus, incident light can be prevented from advancing straight without being diffused. Further, the effect becomes more remarkable when the light diffusing fine particles are allowed to be present in a state of being substantially free of aggregation.

The thickness of the light diffusing element may be appropriately set depending on purposes and desired diffusing characteristics. Specifically, the thickness of the light diffusing element is preferably from 4 μm to 50 μm, more preferably from 4 μm to 20 μm. According to the present invention, a light diffusing element having the extremely high haze as described above and excellent smoothness despite such extremely thin thickness can be obtained.

The light diffusing element is suitably used for a liquid crystal display apparatus, and is particularly suitably used for a collimated backlight front diffusing system. The light diffusing element may be provided alone as a film-shaped or plate-shaped member, or may be provided as a composite member by being bonded to any appropriate base material or polarizing plate. In addition, an antireflection layer may be laminated on the light diffusing element.

A-2. Matrix

As described above, the matrix 10 preferably includes the resin component 11 and the ultrafine particle components 12. As described above, and as illustrated in FIG. 1 and FIG. 2, it is preferred that the ultrafine particle components 12 be dispersed in the resin component 11 so as to form the refractive index modulation region 30 in the vicinity of the surface of each of the light diffusing fine particles 20.

A-2-1. Resin Component

The resin component 11 may be formed of any appropriate material as long as the effects of the present invention are obtained. As described above, the resin component 11 is preferably formed of a compound of the same type as the light diffusing fine particles and of a different type from the ultrafine particle components. With this, the refractive index modulation region can be satisfactorily formed in the vicinity of the surface of each of the light diffusing fine particles. The resin component 11 is more preferably formed of a compound having high compatibility among those of the same type as the light diffusing fine particles. With this, a refractive index modulation region having a desired refractive index gradient can be formed. More specifically, the energy of the entire system becomes more stable in many cases when each light diffusing fine particle is surrounded only by the resin component locally in the vicinity of the light diffusing fine particle, rather than when the resin component is in a state of being homogeneously dissolved or dispersed with the ultrafine particle components. As a result, the weight concentration of the resin component is higher in the region closest to the light diffusing fine particle than the average weight concentration of the resin component in the entire matrix, and decreases with increasing distance from the light diffusing fine particle. Therefore, the refractive index modulation region can be satisfactorily formed in the vicinity of the surface of the light diffusing fine particle.

The resin component is formed of preferably an organic compound, more preferably an ionizing radiation-curable resin. The ionizing radiation-curable resin is excellent in hardness of an applied film. Examples of the ionizing radiation include UV light, visible light, infrared light, and an electron beam. Of those, UV light is preferred, and thus, the resin component is particularly preferably formed of a UV-curable resin. Examples of the UV-curable resin include resins formed of radically polymerizable monomers and/or oligomers such as an acrylate resin (epoxy acrylate, polyester acrylate, acrylic acrylate, or ether acrylate). The molecular weight of a monomer component (precursor) for forming the acrylate resin is preferably from 200 to 700. Specific examples of the monomer component (precursor) for forming the acrylate resin include pentaerythritol triacrylate (PETA: molecular weight: 298), neopentylglycol diacrylate (NPGDA: molecular weight: 212), dipentaerythritol hexaacrylate (DPHA: molecular weight: 632), dipentaerythritolpentaacrylate (DPPA: molecular weight: 578), and trimethylolpropane triacrylate (TMPTA: molecular weight: 296). An initiator may be added to the precursor as required. Examples of the initiator include UV radical generators (such as Irgacure 907, Irgacure 127, and Irgacure 192 manufactured by BASF Japan Ltd.) and benzoyl peroxide. The resin component may contain another resin component other than the ionizing radiation-curable resin. The another resin component may be an ionizing radiation-curable resin, a thermosetting resin, or a thermoplastic resin. Typical examples of the another resin component include an aliphatic (for example, polyolefin) resin and a urethane-based resin. In the case of using the another resin component, the kind and blending amount thereof are adjusted so that the refractive index modulation region is satisfactorily formed.

The refractive indices of the resin component of the matrix and the light diffusing fine particles preferably satisfy the following expression (1).

0<|n_{P}−n_{A}| (1)

In the expression (1), n_{A} represents the refractive index of the resin component of the matrix, and n_{P} represents the refractive index of each of the light diffusing fine particles. |n_{P}−n_{A}| is preferably from 0.01 to 0.10, more preferably from 0.01 to 0.06, particularly preferably from 0.02 to 0.06. When |n_{P}−n_{A}| is less than 0.01, the refractive index modulation region may not be formed. When |n_{P}−n_{A}| is more than 0.10, backscattering may increase.

The refractive indices of the resin component of the matrix, the ultrafine particle components, and the light diffusing fine particles preferably satisfy the following expression (2).

0<|n_{P}−n_{A}|<|n_{P}−n_{B}| (2)

In the expression (2), n_{A} and n_{P} are as described above, and n_{B} represents the refractive index of each of the ultrafine particle components. |n_{P}−n_{B}| is preferably from 0.10 to 1.50, more preferably from 0.20 to 0.80. When |n_{P}−n_{B}| is less than 0.10, the haze value of the light diffusing element becomes 90% or less in many cases, and as a result, in the case where the light diffusing element is incorporated into a liquid crystal display apparatus, light from a light source cannot be sufficiently diffused and a viewing angle may be narrowed. When |n_{P}−n_{B}| is more than 1.50, backscattering may increase.

When the refractive indices of the components have the relationships of the expressions (1) and (2), a light diffusing element having suppressed backscattering while maintaining a high haze can be obtained.

The resin component has a refractive index of preferably from 1.40 to 1.60.

The blending amount of the resin component is preferably from 10 parts by weight to 80 parts by weight, more preferably from 20 parts by weight to 80 part by weight, still more preferably from 20 parts by weight to 65 parts by weight, particularly preferably from 45 parts by weight to 65 parts by weight with respect to 100 parts by weight of the matrix.

The resin component may contain another resin component other than the ionizing radiation-curable resin. The another resin component may be an ionizing radiation-curable resin, a thermosetting resin, or a thermoplastic resin. Typical examples of the another resin component include an aliphatic (for example, polyolefin) resin and a urethane-based resin. In the case of using the another resin component, the kind and blending amount thereof are adjusted so that the refractive index modulation region is satisfactorily formed.

A-2-2. Ultrafine Particle Components

As described above, the ultrafine particle components 12 are each formed of preferably a compound of a different type from the resin component and the light diffusing fine particles to be described later, more preferably an inorganic compound. Preferred examples of the inorganic compound include a metal oxide and a metal fluoride. Specific examples of the metal oxide include zirconium oxide (zirconia) (refractive index: 2.19), aluminum oxide (refractive index: 1.56 to 2.62), titanium oxide (refractive index: 2.49 to 2.74), and silicon oxide (refractive index: 1.25 to 1.46). Specific example of the metal fluoride include magnesium fluoride (refractive index: 1.37) and calcium fluoride (refractive index: 1.40 to 1.43). Those metal oxides and metal fluorides absorb less light and each have a refractive index which is difficult to express with an organic compound such as an ionizing radiation-curable resin or a thermoplastic resin. Therefore, the weight concentration of the ultrafine particle components becomes relatively higher with increasing distance from the interface with the light diffusing fine particle, and thus the refractive index can be significantly modulated. When the refractive index difference between each of the light diffusing fine particles and the matrix is set to be large, a high haze (high light diffusibility) can be realized even with a thin film, and the preventive effect on backscattering is large because the refractive index modulation region is formed. A particularly preferred inorganic compound is zirconium oxide.

It is preferred that the ultrafine particle components also satisfy the expressions (1) and (2). In addition, the refractive indices of the resin component, the ultrafine particle components, and the light diffusing fine particles preferably satisfy the following expression (3). When the refractive indices of the resin component, the ultrafine particle components, and the light diffusing fine particles have such relationship, a light diffusing element having suppressed backscattering while maintaining a high haze value can be obtained.

|n_{P}−n_{A}|<|n_{A}−n_{B}| (3)

The refractive index of each of the ultrafine particle components is preferably 1.40 or less or 1.60 or more, more preferably 1.40 or less or from 1.70 to 2.80, particularly preferably 1.40 or less or from 2.00 to 2.80. When the refractive index is more than 1.40 or less than 1.60, the refractive index difference between each of the light diffusing fine particles and the matrix becomes insufficient and sufficient light diffusibility may not be obtained. In addition, when the light diffusing element is used in a liquid crystal display apparatus adopting a collimated backlight front diffusing system, light from a collimated backlight cannot be diffused enough, which may narrow a viewing angle.

The upper limit of the average primary particle diameter of the ultrafine particle components is 100 nm, preferably 80 nm, more preferably 60 nm, still more preferably 30 nm. The lower limit of the average primary particle diameter of the ultrafine particle components is preferably 10 nm, more preferably 15 nm. As described above, through the use of the ultrafine particle components having an average particle diameter smaller than the wavelength of light, geometric reflection, refraction, and scattering are not caused between each of the ultrafine particle components and the resin component, and a matrix which is optically uniform can be obtained. As a result, a light diffusing element which is optically uniform can be obtained.

The light diffusing element is substantially free of aggregated ultrafine particle components. By virtue of being substantially free of aggregated ultrafine particle components, a light diffusing element having a high haze value and strong diffusibility can be obtained. The phrase “substantially free of aggregated ultrafine particle components” as used herein encompasses not only the case of including only ultrafine particles present as primary particles, but also the case of further including ultrafine particle components having particle diameters sufficiently close to primary particle diameters, and the case of further including a slight amount of aggregated ultrafine particle components within a range in which the effects of the present invention are obtained. The term “ultrafine particle components having particle diameters sufficiently close to primary particle diameters” refers to ultrafine particle components present as secondary particles having particle diameters 10 or less times (preferably 8 or less times, more preferably 5 or less times, still more preferably 3 or less times) as large as the average primary particle diameter. It should be noted that the state of “having particle diameters sufficiently close to primary particle diameters” is herein sometimes expressed as “substantially free of aggregation.” In addition, the particle diameters and the average particle diameter of the ultrafine particle components in the light diffusing element may be measured by observing a cross-section of the light diffusing element using a transmission electron microscope (TEM).

As described above, the light diffusing element may include a slight amount of aggregated ultrafine particle components within a range in which the effects of the present invention are obtained. The light diffusing element including a slight amount of aggregated ultrafine particle components specifically refers to, for example, a light diffusing element in which the number of white spots observed owing to the absence of the ultrafine particle components in the matrix in a predetermined measurement field of view with a transmission electron microscope (TEM) (direct magnification: ×1,200, magnification: ×10,000 (13.9 μm×15.5 μm)) (that is, white spots other than white portions derived from the light diffusing fine particles in the measurement field of view) is less than 10. The white spots occur owing to uneven distribution (that is, aggregation) of the ultrafine particle components, and the number of the white spots is preferably as small as possible. The number of the white spots is preferably less than 8, more preferably less than 5, still more preferably less than 3. The number of the white spots is most preferably 0. In other words, it is preferred that the ultrafine particle components be substantially free of aggregation, and it is more preferred that the ultrafine particle components be present as primary particles.

It is preferred that the ultrafine particle components be subjected to surface modification. By conducting surface modification, the ultrafine particle components can be satisfactorily dispersed in the resin component, and the refractive index modulation region can be satisfactorily formed. Any suitable means may be adopted as surface modification means as long as the effects of the present invention are obtained. The surface modification is typically conducted by applying a surface modifier onto the surface of each of the ultrafine particle components to form a surface modifier layer. Preferred specific examples of the surface modifier include coupling agents such as a silane-based coupling agent and a titanate-based coupling agent, and a surfactant such as a fatty acid-based surfactant. Through the use of such surface modifier, the wettability between the resin component and each of the ultrafine particle components is enhanced, the interface between the resin component and each of the ultrafine particle components is stabilized, the ultrafine particle components can be satisfactorily dispersed in the resin component, and the refractive index modulation region can be satisfactorily formed.

The blending amount of the ultrafine particle components in the application liquid is preferably from 10 parts by weight to 70 parts by weight, more preferably from 35 parts by weight to 55 parts by weight with respect to 100 parts by weight of the matrix to be formed.

A-3. Light Diffusing Fine Particles

The light diffusing fine particles 20 may each also be formed of any appropriate material as long as the effects of the present invention are obtained. As described above, the light diffusing fine particles 20 are each preferably formed of a compound of the same type as the resin component of the matrix. For example, when the ionizing radiation-curable resin for forming the resin component of the matrix is an acrylate-based resin, it is preferred that each of the light diffusing fine particles be also formed of an acrylate-based resin. More specifically, when the monomer component of the acrylate-based resin for forming the resin component of the matrix is, for example, PETA, NPGDA, DPHA, DPPA, and/or TMPTA as described above, the acrylate-based resin for forming each of the light diffusing fine particles is preferably any of polymethyl methacrylate (PMMA), polymethyl acrylate (PMA), and copolymers thereof, and cross-linked products thereof. As components to be copolymerized with PMMA and PMA, there are given polyurethane, polystyrene (PS), and a melamine resin. The light diffusing fine particles are each particularly preferably formed of PMMA. This is because PMMA has appropriate relationships with the resin component and the ultrafine particle components of the matrix in terms of refractive index and thermodynamic characteristics. Further, the light diffusing fine particles preferably have a cross-linked structure (three-dimensional network structure). Through the adjustment of the density (cross-linking degree) of the cross-linked structure, the degree of freedom of polymer molecules forming the light diffusing fine particles at the surfaces of the fine particles can be controlled, and hence the dispersed state of the ultrafine particle components can be controlled. As a result, a refractive index modulation region having a desired refractive index gradient can be formed.

It is preferred that the resin component permeate the light diffusing fine particles and the resin component be contained in the light diffusing fine particles in the light diffusing element. When the resin component permeates the light diffusing fine particles, the refractive index modulation region can be formed on the inside of each of the light diffusing fine particles in the vicinity of the surface thereof, and a light diffusing element having a high haze value, strong diffusibility, and suppressed backscattering can be obtained. In addition, light diffusing fine particles having a large average particle diameter can be obtained. The permeation range of the resin component in the light diffusing fine particles is preferably 80% or more, more preferably 85% or more, still more preferably from 85% to 100% with respect to the average particle diameter of the light diffusing fine particles in the light diffusing element. When the permeation range falls within such range, the refractive index modulation region can be satisfactorily formed to suppress backscattering. The permeation range may be controlled by adjusting, for example, the materials for the resin component and the light diffusing fine particles, the cross-linking density of the light diffusing fine particles, the kind of the organic solvent to be used in the manufacture, and the period of time of standing still and the temperature during the standing still in the manufacture.

The light diffusing fine particles in the light diffusing element have an average primary particle diameter of preferably from 1 μm to 5 μm, more preferably from 2 μm to 5 μm, still more preferably from 2.5 μm to 4 μm. When the average primary particle diameter falls within such range, a light diffusing element having a high haze value, having strong diffusibility, and being capable of suppressing the transmission of straight advancing light can be obtained. When the light diffusing fine particles are swollen in a manufacturing step, the term “light diffusing fine particles in the light diffusing element” as used herein means light diffusing fine particles after swelling, that is, light diffusing fine particles whose particle diameters have been increased as compared to those at the time of loading of the light diffusing fine particles. It should be noted that the average particle diameter of the light diffusing fine particles in the light diffusing element may be measured by observing a cross-section of the light diffusing element using a transmission electron microscope (TEM).

It is preferred that the light diffusing fine particles in the light diffusing element be substantially free of aggregation. When the light diffusing fine particles are present in a state of being substantially free of aggregation, a light diffusing element having a high haze value, having strong diffusibility, and being capable of suppressing the transmission of straight advancing light can be obtained. The phrase “substantially free of aggregation” as used herein refers to a state of having particle diameters sufficiently close to primary particle diameters. Therefore, the particles which are “substantially free of aggregation” encompass not only individually separated particles (single particles), but also particles in a state in which a plurality of particles have gathered into a mass within a range in which the effects of the present invention are obtained. Specifically, the light diffusing fine particles which are “substantially free of aggregation” encompass light diffusing fine particles present as primary particles, and light diffusing fine particles present as secondary particles having particle diameters 2.5 or less times as large as the average primary particle diameter. The particle diameter of each of the light diffusing fine particles in the light diffusing element is preferably 2 or less times, more preferably 1.5 or less times as large as the average primary particle diameter.

The average particle diameter of the light diffusing fine particles in the light diffusing element is preferably ½ or less (for example, from ½ to 1/20) of the thickness of the light diffusing element. With the average particle diameter having such ratio to the thickness of the light diffusing element, a plurality of the light diffusing fine particles can be arranged in the thickness direction of the light diffusing element, and hence incident light can be multiply diffused while the light passes through the light diffusing element. As a result, sufficient light diffusibility can be obtained.

The standard deviation of the weight average particle diameter distribution of the light diffusing fine particles in the light diffusing element is preferably 1.0 μm or less, more preferably 0.5 μm or less, particularly preferably 0.1 μm or less. The standard deviation of the weight average particle diameter distribution of the light diffusing fine particles is preferably as small as possible, but its practical lower limit value is, for example, 0.01 μm. In addition, the weight average particle diameter distribution of the light diffusing fine particles is preferably monodispersed, and for example, the light diffusing fine particles have a coefficient of variation in weight average particle diameter distribution ((standard deviation of particle diameter)×100/(average particle diameter)) of preferably 20% or less, more preferably 15% or less. The coefficient of variation in weight average particle diameter distribution of the light diffusing fine particles is preferably as small as possible, but its practical lower limit value is, for example, 5%. When light diffusing fine particles each having a small particle diameter relative to the weight average particle diameter are present in a large number, the diffusibility may increase too much to satisfactorily suppress backscattering. When light diffusing fine particles each having a large particle diameter relative to the weight average particle diameter are present in a large number, a plurality of the light diffusing fine particles cannot be arranged in the thickness direction of the light diffusing element, and multiple diffusion may not be obtained. As a result, the light diffusibility may become insufficient.

Any appropriate shape may be adopted as the shape of each of the light diffusing fine particles depending on purposes. Specific examples thereof include a spherical shape, a scale-like shape, a plate shape, an elliptic shape, and an amorphous shape. In many cases, spherical fine particles may be used as the light diffusing fine particles.

It is preferred that the light diffusing fine particles also satisfy the expressions (1) and (2). The refractive index of each of the light diffusing fine particles is preferably from 1.30 to 1.70, more preferably from 1.40 to 1.60.

A-4. Method of Manufacturing Light Diffusing Element

A method of manufacturing a light diffusing element according to one embodiment of the present invention includes the steps of: applying an application liquid onto a base material, the application liquid being prepared by dissolving or dispersing a precursor (monomer) of a resin component of a matrix, ultrafine particle components, and light diffusing fine particles in an organic solvent (referred to as step A); drying the application liquid applied onto the base material (referred to as step B); and polymerizing the precursor (referred to as step C).

(Step A)

The precursor of a resin component, the ultrafine particle components, and the light diffusing fine particles are as described in the section A-2-1, the section A-2-2, and the section A-3, respectively. The application liquid is typically a dispersion in which the ultrafine particle components and the light diffusing fine particles are dispersed in the precursor and a volatile solvent. As means for dispersing the ultrafine particle components and the light diffusing fine particles, dispersion treatment with a stirring machine is preferably used. This is because a sufficient shear is applied to the ultrafine particle components and the light diffusing fine particles, and hence ultrafine particle components and light diffusing fine particles which are substantially free of aggregation can be obtained. As the stirring machine, a disper-type stirring machine is preferably used. A stirring time is preferably 15 minutes or more, more preferably from 15 minutes to 60 minutes. The dispersion treatment is preferably performed immediately before the application of the application liquid onto the base material.

In one embodiment, the application liquid may be prepared by mixing the light diffusing fine particles in the organic solvent to swell the light diffusing fine particles in advance, and then adding the precursor of a resin component and the ultrafine particle components into the organic solvent. When the light diffusing fine particles are mixed in the organic solvent to swell the light diffusing fine particles in advance, the application liquid can be subjected to the subsequent step immediately after being prepared, that is, without being left to stand still. As a result, the light diffusing fine particles and the ultrafine particle components can be prevented from aggregating.

Specific examples of the organic solvent include butyl acetate, methyl isobutyl ketone, ethyl acetate, isopropyl acetate, 2-butanone (methyl ethyl ketone), cyclopentanone, toluene, isopropyl alcohol, n-butanol, cyclopentane, and water.

It is preferred that the organic solvent have a boiling point of preferably 70° C. or more, more preferably 100° C. or more, particularly preferably 110° C. or more, most preferably 120° C. or more. When an organic solvent having relatively low volatility is used, rapid volatilization of the organic solvent during its drying can be prevented, and hence the light diffusing fine particles and the ultrafine particle components can be prevented from aggregating.

The application liquid may further contain any appropriate additive depending on purposes. For example, in order to satisfactorily disperse the ultrafine particle components, a dispersant may be suitably used. Other specific examples of the additive include a UV absorbing agent, a leveling agent, and an antifoaming agent.

The blending amount of the precursor of a resin component in the application liquid is as described in the section A-2-1, and the blending amount of the ultrafine particle components is as described in the section A-2-2. The upper limit of the blending amount of the light diffusing fine particles is preferably 40 parts by weight, more preferably 30 parts by weight, particularly preferably 20 parts by weight with respect to 100 parts by weight of the matrix. The lower limit of the blending amount of the light diffusing fine particles is preferably 5 parts by weight, more preferably 10 parts by weight, still more preferably 15 parts by weight with respect to 100 parts by weight of the matrix.

The solid content of the application liquid may be adjusted so as to be preferably from about 10 wt % to 70 wt %. With such solid content, an application liquid having a viscosity which allows easy application can be obtained.

Any appropriate film may be adopted as the base material as long as the effects of the present invention are obtained. Specific examples thereof include a triacetyl cellulose (TAC) film, a polyethylene terephthalate (PET) film, a polypropylene (PP) film, a nylon film, an acrylic film, and a lactone-modified acrylic film. The base material may be subjected to surface modification such as easy adhesion treatment, or may contain an additive such as a lubricant, an antistat, or a UV absorber, as required.

Any appropriate method using a coater may be adopted as a method of applying the application liquid onto the base material. Specific examples of the coater include a bar coater, a reverse coater, a kiss coater, a gravure coater, a die coater, and a comma coater.

(Step B)

Any appropriate method may be adopted as a method of drying the application liquid. Specific examples thereof include natural drying, drying by heating, and drying under reduced pressure. Of those, drying by heating is preferred. The heating temperature is preferably from 60° C. to 150° C., more preferably from 60° C. to 100° C., still more preferably from 60° C. to 80° C. When the heating temperature is more than 150° C., the application liquid surface rapidly changes. Accordingly, sufficient smoothness may not be obtained because the light diffusing fine particles cannot follow the change of the application liquid surface. The heating time is, for example, from 30 seconds to 5 minutes.

(Step C)

Any appropriate method may be adopted as the polymerization method depending on the kind of the resin component (thus, the precursor thereof). For example, in the case where the resin component is an ionizing radiation-curable resin, the precursor is polymerized by irradiation with ionizing radiation. In the case of using UV light as the ionizing radiation, the integrated light quantity is preferably from 50 mJ/cm² to 100 mJ/cm², more preferably from 200 mJ/cm² to 400 mJ/cm². The transmittance of the ionizing radiation with respect to the light diffusing fine particles is preferably 70% or more, more preferably 80% or more. In addition, for example, in the case where the resin component is a thermosetting resin, the precursor is polymerized by heating. The heating temperature and the heating time may be appropriately set depending on the kind of the resin component. It is preferred that the polymerization be conducted by irradiation with ionizing radiation. The irradiation with ionizing radiation can cure an applied film while satisfactorily keeping a refractive index modulation region, and hence a light diffusing element having a satisfactory diffusion characteristic can be manufactured. Simultaneously with the formation of the matrix by the polymerization of the precursor, a refractive index modulation region is formed in the vicinity of the surface of each of the light diffusing fine particles. That is, according to the manufacturing method of the present invention, the precursor permeating the inside of each of the light diffusing fine particles and the precursor not permeating the light diffusing fine particles can be simultaneously polymerized to form the refractive index modulation region in the vicinity of the surface of the light diffusing fine particles and to simultaneously form the matrix.

The polymerization step (step C) may be performed before the drying step (step B), or may be performed after the step B. The drying step (step B) is preferably performed before the polymerization step (step C). This is because the heating can promote the permeation of the precursor of a resin component into the light diffusing fine particles.

Needless to say, the method of manufacturing a light diffusing element according to this embodiment may include, in addition to the step A to the step C, any appropriate step, treatment, and/or operation at any appropriate time point. The kind of such step or the like and the time point at which such step or the like is performed may be appropriately set depending on purposes. For example, when the components are simultaneously mixed in the step A, the application liquid may be left to stand still for a predetermined period of time before being applied. When the application liquid is left to stand still for a predetermined period of time, the precursor of a resin component can be allowed to sufficiently permeate the light diffusing fine particles. The period of time of the standing still is preferably from 1 hour to 48 hours, more preferably from 2 hours to 40 hours, still more preferably from 3 hours to 35 hours, particularly preferably from 4 hours to 30 hours.

Thus, the light diffusing element as described in the section A-1 to the section A-3 is formed on the base material.

Now, the present invention is specifically described byway of Examples. However, the present invention is not limited by these Examples. Evaluation methods in Examples are as described below. In addition, unless otherwise stated, “part(s)” and “%” in Examples are by weight.

(1) Thickness of Light Diffusing Element

The total thickness of a base material and a light diffusing element was measured with a microgauge-type thickness meter (manufactured by Mitutoyo Corporation), and the thickness of the base material was subtracted from the total thickness to calculate the thickness of the light diffusing element.

(2) Average Particle Diameters and Standard Deviations of Light Diffusing Fine Particles and Ultrafine Particle Components in Light Diffusing Element

A laminate of a light diffusing element and a base material obtained in each of Examples and Comparative Example was sliced so as to have a thickness of 0.1 μm with a microtome while being cooled with liquid nitrogen to prepare a measurement sample. The measurement sample was observed using a transmission electron microscope (TEM), and the particle diameters of a light diffusing fine particle and an ultrafine particle component in the light diffusing element were measured based on a TEM image through the use of image analysis software. The measurement was performed at 20 randomly selected sites to calculate the average particle diameters and the standard deviations of the light diffusing fine particles and the ultrafine particle components in the light diffusing element.

(3) Aggregation of Ultrafine Particle Components

A laminate of a light diffusing element and a base material obtained in each of Examples and Comparative Example was sliced so as to have a thickness of 0.1 μm with a microtome while being cooled with liquid nitrogen to prepare a measurement sample. A two-dimensional image of a cross-section of the measurement sample was observed using a transmission electron microscope (TEM) (manufactured by Hitachi, Ltd., trade name: “H-7650”, accelerating voltage: 100 kV), and the occurrence of uneven distribution of ultrafine particle components in the light diffusing element of the measurement sample was checked. In a measurement field of view (13.9 μm×15.5 μm) at a direct magnification of ×1,200 and a magnification of ×10,000, the number of portions observed as white spots owing to the absence of the ultrafine particle components in the matrix (namely white spots other than white portions derived from light diffusing fine particles in the measurement field of view) was counted. For each laminate of a light diffusing element and a base material obtained in Examples and Comparative Example, the numbers of white spots were counted as described above at 20 sites, and an average value thereof was calculated. The average value is shown in Table 1. As the number of white spots increases, the degree of the aggregation of the ultrafine particle components is evaluated to be higher.

(4) Aggregation of Light Diffusing Fine Particles

TEM observation was performed in the same manner as in the section (2) to confirm the presence or absence of a light diffusing fine particle having a particle diameter 2.5 or more times as large as an average primary particle diameter (substantial secondary particle). When no substantial secondary particle is found, it is determined that particles are substantially free of aggregation.

(5) Haze Value

Measurement was performed with a haze meter (manufactured by Murakami Color Research Laboratory Co., Ltd., trade name: “HN-150”) in accordance with a method specified in JIS 7136.

(6) Backscattering Ratio

A laminate of a light diffusing element and a base material obtained in each of Examples and Comparative Examples was bonded onto a black acrylic plate (manufactured by Sumitomo Chemical Co., Ltd., trade name: “SUMIPEX” (trademark), thickness: 2 mm) through intermediation of a transparent pressure-sensitive adhesive to prepare a measurement sample. The integrated reflectance of the measurement sample was measured with a spectrophotometer (manufactured by Hitachi Ltd., trade name: “U4100”). On the other hand, a laminate of a base material and a transparent applied layer was produced as a control sample, using an application liquid in which fine particles were removed from the above-mentioned application liquid for a light diffusing element and the integrated reflectance (i.e., surface reflectance) thereof was measured in the same way as described above. The integrated reflectance (surface reflectance) of the control sample was subtracted from the integrated reflectance of the measurement sample to calculate a backscattering ratio of the light diffusing element.

### Example 1

15 Parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles, and 30 parts of a mixed solvent of butyl acetate and MEK (weight ratio: 50/50) serving as an organic solvent were mixed and stirred for 60 minutes to prepare a mixed liquid.

Next, to the resultant mixed liquid, 100 parts of a hard coat resin (manufactured by JSR Corporation, trade name: “OPSTAR KZ6661” (containing MEK/MIBK)) containing 62% of zirconia nanoparticles (average particle diameter: 60 nm, refractive index: 2.19) serving as ultrafine particle components, 22 parts of pentaerythritol triacrylate (manufactured by Osaka Organic Chemical Industry Ltd., trade name: “Viscoat #300”, refractive index: 1.52, molecular weight: 298) serving as a precursor of a resin component, 0.5 part of a photopolymerization initiator (manufactured by Ciba Specialty Chemicals, trade name: “Irgacure 907”), and 0.5 part of a leveling agent (manufactured by DIC Corporation, trade name: “GRANDIC PC 4100”) were added, and the mixture was stirred using a disper for 15 minutes to prepare an application liquid.

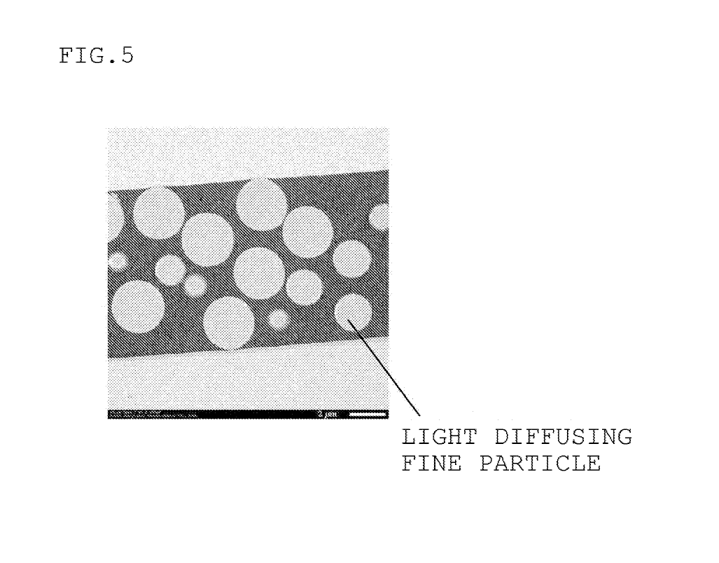

The application liquid was applied onto a TAC film (manufactured by Fujifilm Corporation, trade name: “FUJITAC”) using a bar coater immediately after the preparation and heated at 60° C. for 1 minute, followed by irradiation with UV light having an integrated light quantity of 300 mJ. Thus, a light diffusing element having a thickness of 10 μm was obtained. The obtained light diffusing element was subjected to the evaluations (2) to (6). Further, a TEM image of a cross-section of the light diffusing element is shown in FIG. 5.

### Example 2

A light diffusing element was obtained in the same manner as in Example 1 except that, in Example 1, particles available under the trade name “OPSTAR KZ6706” from JSR Corporation (containing propylene glycol monomethyl ether (PEGME)) (average particle diameter: 30 nm, refractive index: 2.19) were used instead of 100 parts of the hard coat resin (manufactured by JSR Corporation, trade name: “OPSTAR KZ6661” (containing MEK/MIBK)) containing 62% of zirconia nanoparticles (average particle diameter: 60 nm, refractive index: 2.19) serving as ultrafine particle components. The obtained light diffusing element was subjected to the evaluations (2) to (6). The results are shown in Table 1.

### Comparative Example 1

To 100 parts of a hard coat resin (manufactured by JSR Corporation, trade name: “OPSTAR KZ6661” (containing MEK/MIBK)) containing 62% of zirconia nanoparticles (average particle diameter: 60 nm, refractive index: 2.19) serving as ultrafine particle components, 11 parts of a 50% solution of pentaerythritol triacrylate (manufactured by Osaka Organic Chemical Industry Ltd., trade name: “Viscoat #300”, refractive index: 1.52) serving as a precursor of a resin component in a mixed solvent of butyl acetate and MEK, 0.5 part of a photopolymerization initiator (manufactured by Ciba Specialty Chemicals, trade name: “Irgacure 907”), 0.5 part of a leveling agent (manufactured by DIC Corporation, trade name: “GRANDIC PC 4100”), and 15 parts of polymethyl methacrylate (PMMA) fine particles (manufactured by Sekisui Plastics Co., Ltd., trade name: “XX131AA”, average particle diameter: 2.5 μm, refractive index: 1.49) serving as light diffusing fine particles were added. The mixture was subjected to ultrasound treatment for 5 minutes to prepare an application liquid having the above-mentioned components homogeneously dispersed therein. The application liquid was left to stand still for 24 hours, and was then applied onto a TAC film (manufactured by Fujifilm Corporation, trade name: “FUJITAC”) using a bar coater and heated at 60° C. for 1 minute, followed by irradiation with UV light having an integrated light quantity of 300 mJ. Thus, a light diffusing element having a thickness of 10 μm was obtained. The obtained light diffusing element was subjected to the evaluations (2) to (6). The results are shown in Table 1.

TABLE 1

| | | | Aggregation of ultrafine | | | |
|---|---|---|---|---|---|---|
| | Primary particle | Heating | particle components | Aggregation of light | | |
| | diameter of ultrafine | temperature | (number of white spots | diffusing fine | Haze | Backscattering |
| | particle components (nm) | (° C.) | (spots)) | particles | (%) | (%) |
| Example 1 | 60 | 60 | 2 | Absent | 99.1 | 0.29 |
| Example 2 | 30 | 60 | 3 | Absent | 99.2 | 0.20 |
| Comparative | 60 | 60 | 28 | Present | 98.5 | 0.39 |
| Example 1 | | | | | | |

As apparent from Table 1 above, according to the present invention, a light diffusing element having a high haze value, strong diffusibility, and suppressed backscattering can be obtained because the ultrafine particle components have small particle diameters and the light diffusing element is substantially free of aggregated ultrafine particle components.

### INDUSTRIAL APPLICABILITY

The light diffusing element obtained by the manufacturing method of the present invention may be suitably used for a viewer-side member for a liquid crystal display apparatus, a backlight member for a liquid crystal display apparatus, or a diffusing member for illumination equipment (e.g., organic EL, LED), and may be particularly suitably used as a front diffusing element in a collimated backlight front diffusing system.

### REFERENCE SIGNS LIST

10 matrix
11 resin component
12 ultrafine particle component
20 light diffusing fine particle
30 refractive index modulation region
100 light diffusing element

1. A light diffusing element, comprising:
a matrix including a resin component and ultrafine particle components; and
light diffusing fine particles dispersed in the matrix,
wherein the ultrafine particle components have an average primary particle diameter of 100 nm or less, and
wherein the light diffusing element is substantially free of aggregated ultrafine particle components.

2. The light diffusing element according to claim 1,
wherein the light diffusing fine particles have an average primary particle diameter of from 1 μm to 5 μm,
wherein the light diffusing fine particles have a coefficient of variation in weight average particle diameter distribution of 20% or less, and
wherein the light diffusing fine particles are substantially free of aggregation.

3. The light diffusing element according to claim 1, wherein the ultrafine particle components have an average primary particle diameter of 30 nm or less.

4. The light diffusing element according to claim 1,
wherein refractive indices of the resin component, the ultrafine particle components, and the light diffusing fine particles satisfy the following expression (i), and
wherein the light diffusing element has a refractive index modulation region in a vicinity of a surface of each of the light diffusing fine particles:

|n_{P}−n_{A}|<|n_{P}−n_{B}| (i)
in the expression (i), n_{A} represents the refractive index of the resin component of the matrix, n_{B} represents the refractive index of each of the ultrafine particle components of the matrix, and n_{P} represents the refractive index of each of the light diffusing fine particles.
